(19) United States
(12) Patent Application Publication
(10) Pub. No.: US 2021/0192543 A1
(43) Pub. Date: Jun. 24, 2021

(54) METHOD FOR OFFERING GUIDANCE TO THE AGRIBUSINESS MARKET ON DIFFERENT PARAMETERS CONCERNING AGRICULTURAL PESTICIDES

(71) Applicant: YEB REPRESENTAÇÃO COMERCIAL E CONSULTORIA EMPRESARIAL LTDA, Rio Claro (BR)

(72) Inventor: Felix Sanz Yeboles, Rio Claro (BR)

(21) Appl. No.: 15/733,365

(22) PCT Filed: Sep. 16, 2019
(86) PCT No.: PCT/BR2019/050402

§ 371 Date: Jul. 10, 2020

(30) Foreign Application Priority Data
Sep. 17, 2018 (BR) BR1020180688308

(51) Int. Cl. G06Q 30/02; G06Q 50/02; G06Q 10/10

(52) U.S. Cl. CPC G06Q 30/0201; G06Q 30/0206; G06Q 10/10; G06Q 50/02

(57) ABSTRACT

This patent application concerns the invention of a new METHOD FOR OFFERING GUIDANCE TO THE AGRIBUSINESS MARKET ON DIFFERENT PARAMETERS CONCERNING AGRICULTURAL PESTICIDES, specifically from a technical and marketing advisor regarding agricultural pesticides. The invention comprises guidance to be disseminated through some form of informative media, in order to generate a report that encompasses “X” subcategories which inform specific content regarding the pesticide market.

### FIELD OF THE INVENTION

This patent application concerns a patent for a new method for offering guidance to the agribusiness market on different parameters concerning agricultural pesticides, specifically from a technical or marketing advisor regarding agricultural pesticides. Its field of application is the agribusiness sector.

### BRIEF SUMMARY

The present invention consists of offering the agribusiness market, through any media platform, technical and commercial guidance on different parameters foreseen in the agricultural pesticides sector. For example, data can be offered on the principal agricultural pesticides used in the sugarcane, citrus, timber and grain sectors in Brazil.

These data are divided into market information, such as price, import data, future trends, brands sold in Brazil and exchange relationship with user cultures, among others. It also provides technical guidance, such as doses for substitution between two different pesticides, and also on the pests that they fight.

So, the purpose of the invention is to advise buyers from agribusiness companies on the agricultural pesticides market, adding value to the pre-existing knowledge of these users (buyers) concerning the agricultural pesticide segment and also to support strategic decision-making within the company.

### STATE OF THE ART

Agricultural pesticides are strategic items of the purchasing portfolio of rural producers of sugarcane, soybeans, corn, citrus fruit and timber, among other crops. Which is to say, the annual expenditure on agricultural pesticides used on these crops is significant. Because it is a complex market with a wide variety of products, applications, brands and is governed by the international market, buyers of agricultural pesticides have little or no knowledge about the behavior of this segment to help them when negotiating with companies that supply these products.

The method, according to the invention, aims to fill this gap in the knowledge of buyers of agricultural pesticides. At present, no other method is known which comprises the same type of orientation for the pesticides market, due to the complexity of obtaining and processing said information. The invention's format is exclusive and offers a unique and different solution through its content.

### Inherent Problems of the State of the Art

The technical deficiency that some buyers suffer when it comes to understanding pesticide products, their use, which pests they affect and which substitutes can be used for the same purpose, are day-to-day challenges for rural producers of different crops, which can create multiple difficulties and applications with standard deviations.

### The Invention in Relation to the State of the Art

With the method of the present invention, buyers of agricultural pesticides are provided with guidance on this market, such as international price dynamics, products available for purchase, the price charged in the national market to provide a benchmark for the quotations or prices already negotiated, future prospects and an analysis of the demand for the principal crops. Additionally, the invention is able to reveal the chemical supply chain of each active ingredient used as a pesticide. In a novel way, the method of the invention analyzes the market, trends and behaviors of the raw materials used in the production of pesticides. Finally, the invention also analyzes the impact of pesticide consumption on different cultures and different countries, in addition to evaluating how this demand may impact the domestic consumer.

### Objectives of the Invention

It is the objective of the invention to supply professionals who work with agricultural pesticides at agribusiness companies with technical and marketing guidance on these types of products.

### DESCRIPTION OF THE DRAWINGS

The invention will be described below in a preferential form of embodiment, and, for the purposes of improved illustration, reference will be made to the attached drawing in which it is represented:

FIG. 1: Flowchart showing the steps of the method according to the invention.

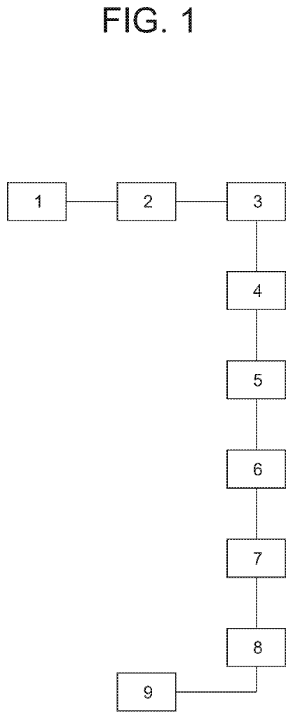

### DETAILED DESCRIPTION OF THE INVENTION

The method for offering the agribusiness market guidance on different parameters involving agricultural pesticides, which is the object of this patent application, is composed of guidance to be revealed through some form of informative media, in order to generate a report that encompasses “X” subcategories that inform specific content regarding the pesticide market, namely:
Executive summary (1): summary of the principal information provided in the report. It is targeted at the senior management of agribusiness companies, in order to provide a brief overview of the pesticide market;
Trends (2): annexed to the executive summary (1), this category presents the price trends of the products for the next 6 (six) months, with the aim of supporting traders in future strategies;
International technical product market (3): explains the state of the production of technical pesticide products by the principal global producers. It seeks to anticipate potential impacts on the national market;
National formulas market (4): explains the state of the products formulated in Brazil, such as production, inventory, nationalization, sales channels, among others. Presents the more short-term impacts for the pesticide buyer;
Raw materials (5): informs the market situation of the raw materials used in the pesticides, which are the focus of the report. These raw materials are based on the chemical structure;
Breakdown of the pesticide of the month (6):
principal brands marketed;
patent of the pesticide;
registrations obtained and registrations on the list yet to be released;
period of application;
pests that they combat;
international price history;
national prices;
market share in the crops where it is marketed;
exchange relationship;
analysis of global crop protection;
Demand (7): explains the demand for pesticides in Brazil and the principal countries that consume pesticides;
New technologies (8): brief commentary on new technologies applied to agricultural pesticides;
Exchange rate (9): history of the exchange rate for tracking by the trader. For example:
the 16 products tracked for the sugarcane market are: xxxxxxxxx . . . ;
the X products tracked for the timber market are: xxxxxxx . . . ;
the Y products tracked for the timber market are: xxxxxxx . . . ;
the Z products tracked for the timber market are: xxxxxxx . . . ;
the N products tracked for the timber market are: xxxxxxx . . . .

### EXAMPLES OF EMBODIMENT

For example, an Executive Summary (1) may contain guidance such as:

“The European Union has decided to ban the use of Tiametoxam and Imidacloprid by the end of 2018, which should impact the availability of pesticides in Brazil at the next peak usage in December. Chinese companies are presenting better financial results this first quarter with profitability rising by 148% compared to the first quarter of 2017. Low product availability is expected to continue in China in 2018. Glyphosate production is expected to increase by only 30,000 tons annually in 2018, and producers are already looking for other assets with the same application but at a lower cost, such as Glufosinate. The Argentine company Red Surgos is investing in its pesticide plant and may increase the availability of generics such as 2.4D in Brazil, a country that the company will potentially export to. The domestic market is experiencing reduced activity due to the prolonged period of drought and producers are also worried by the rise in the exchange rate. Cooperatives still have products at more competitive costs as a result of purchases made in the first quarter, which may represent an opportunity for spot purchases.”

The Trend item may contain guidelines such as:

“for the end of the first half of 2018 there is expected to be an increase in the price of Benfuracarb, Diuron+Hexazinone and Fipronil. While Flumioxazin retains its bearish outlook along with Diclosulan, due to the drop in the international price. For the second half most pesticides should remain stable. Isoxaflutole and Sulfentrazone are expected to fall. Bayer's product is already at a lower international price and may have help to reduce the national price. Tables and charts may be related to this item, in addition to other guidelines on products.”

Market information and guidance may also be revealed on raw materials.

The international technical product market item may contain guidance such as:

“In Europe, the external use of the insecticides imidacloprid, clothianidin and thiamethoxam should be banned by the end of 2018. According to EFSA's risk assessment, the three neonicotinoids pose a risk to wild bees. Farmers may still be able to use these insecticides in controlled systems, such as in greenhouses. Data released by the California Department of Pesticide Regulation show that farmers from the State of California are using near-record levels of pesticides. The most recent data shows that about 209,000 tons of active ingredients were used in the principal agricultural state of the United States. In China the rise in the price of pesticides is already generating financial results for suppliers. Revenues from this market increased by 25.9% compared to the first quarter of 2017 and 2018. In net income, the increase was even greater: 148.7% by the same comparison. Nevertheless, for the remainder of 2018 it is expected that supply will be tight and prices will remain high. In March/18 there was a 0.4% reduction in the production of intermediate chemicals in the country. One of the most strongly affected products, Glyphosate, is expected to experience an increase in production of only 30,000 tons in 2018 which is yet to be confirmed by one of the manufacturers. While some producers are beginning to focus on other options such as Glufosinate, which has a lower cost and has proven effective as a substitute for Paraquat. Another market on the Chinese radar is ethane. With improved prices in the international market, especially the American market, some companies are looking to invest in ethylene plants, the basis of many pesticides, and take advantage of the current price situation. Following approval by the European Union and the U.S., on April 20 Russia's antitrust authorities approved Bayer's $57 billion acquisition of Monsanto. The condition for approval was that the German company transfer its technology to companies based in the country. In India, companies that manufacture agricultural inputs such as seeds, fertilizers and agrochemicals are expected to double growth in sales and net profits in 2018/2019 due to the possibility of an increase in minimum price programs for regional crops. Increased rural consumption and growth in rural income is driving positive sales of agricultural raw materials. Red Surcos, Argentina's largest pesticide company, plans to double its production capacity in the coming years. The principal objective is to grow in important world markets such as Russia, Ukraine and Brazil, in addition to meeting the country's domestic demand. To this end, the company has already raised about 250 million in the financial markets, a sum that will be targeted at the expansion of production capacity to meet the growing national and international demand. The money will help the company export the 2,4-D, dicamba and picloram products to Brazil.”

The national formulas market may contain guidelines such as:

“After a period of fluctuations in the dollar price of pesticides, in the last month greater stability was noted in the availability of product and consequently in the price. However, the significant rise in the exchange rate noted in recent weeks has strongly impacted the price in reals. This scenario has not yet impacted the price in the main cooperatives, as they still have stocks of products purchased in the first quarter. Due to the current drought that has lasted for up to 50 days in some regions of the Southeast, rural producers are delaying the application and, consequently, the purchase of pesticides. For this reason the stocks in the cooperatives are not projected to be reduced and remain at a more competitive price, providing an opportunity for short-term spot volumes. Some products still face availability difficulties. One of these is Metribuzin 700 g/Kg which is still adopting a price above the historical average of about US$23.00. Glyphosate also continues to face shortages and Adama has reported that in the last 3 months it had no product to market. The principal reason remains the reduced supply in China which has shut down 50% of its glyphosate production capacity. After a period of growth in the market, generic items saw their market share reduced in the last year. According to Aenda, the power of specialty companies has enabled them to increase sales of these types of products, based on marketing and new high-performance products. However, it is expected that there will be a resumption in the use of generic products in the sugarcane market, since many molecules will have registrations released in the next 2 years. According to Albaugh, it is expected that, in just five years, 80% of the portfolio of agrochemicals available in Brazil will be formulated by generics. Low pesticide sales continue to be reflected in company performance in the first quarter of the year. DowDupont suffered the biggest impact in the agricultural sector, with a 25% drop in sales. Basf and Bayer also suffered reductions with a fall in pesticide sales of around 7% and 5.6%, respectively. The principal cause of this impact, according to the companies, was the exchange rate fluctuation during the period. While DowDupont's result, on the other hand, was due to the change in its pesticide portfolio, which they hope to revive with the launch of new products at the end of the year.”

The detailing of the pesticide of the month item may contain several guidelines such as: products of the month (including tables), suppliers and their brands, issues to patent, pests to combat, period of use, indirect substitutes, among other important questions for the rural producer when choosing this or that product.

1) METHOD FOR OFFERING GUIDANCE TO THE AGRIBUSINESS MARKET ON DIFFERENT PARAMETERS CONCERNING AGRICULTURAL PESTICIDES, wherein it comprises guidance to be disseminated through some form of informative media, in order to generate a report that encompasses “X” subcategories which inform specific content regarding the pesticide market, namely:
Executive summary (1);
Trends (2);
International technical product market (3);
National formula market (4);
Raw materials (5);
Detailing of the pesticide of the month (6);
Demand (7);
New technologies (8):
Exchange rate (9).

2) METHOD FOR OFFERING GUIDANCE TO THE AGRIBUSINESS MARKET ON DIFFERENT PARAMETERS CONCERNING AGRICULTURAL PESTICIDES, according to claim 1, wherein the executive summary (1) contains a summary of the principal information provided in the report, which is targeted at the senior management of agribusiness companies, in order to provide a brief overview of the pesticide market.

3) METHOD FOR OFFERING GUIDANCE TO THE AGRIBUSINESS MARKET ON DIFFERENT PARAMETERS CONCERNING AGRICULTURAL PESTICIDES, according to claim 1, wherein the trends (2) include an annex to the executive summary (1), where this category presents the price trends of products for the next 6 (six) months, with the aim of supporting traders in their future strategies.

4) METHOD FOR OFFERING GUIDANCE TO THE AGRIBUSINESS MARKET ON DIFFERENT PARAMETERS CONCERNING AGRICULTURAL PESTICIDES, according to claim 1, wherein the international technical product market (3) explains the state of the production of technical pesticide products by the principal global producers, in addition to seeking to anticipate potential impacts on the national market.

5) METHOD FOR OFFERING GUIDANCE TO THE AGRIBUSINESS MARKET ON DIFFERENT PARAMETERS CONCERNING AGRICULTURAL PESTICIDES, according to claim 1, wherein the national formula market (4) explains the status of the products formulated in Brazil, such as production, inventory, nationalization, sales channels, among others; and presents the more short-term impacts to the pesticide buyer.

6) METHOD FOR OFFERING GUIDANCE TO THE AGRIBUSINESS MARKET ON DIFFERENT PARAMETERS CONCERNING AGRICULTURAL PESTICIDES, according to claim 1, wherein raw materials (5) inform the market situation of the raw materials used in the pesticides that are the focus of the report; these raw materials are based on the chemical chain.

7) METHOD FOR OFFERING GUIDANCE TO THE AGRIBUSINESS MARKET ON DIFFERENT PARAMETERS CONCERNING AGRICULTURAL PESTICIDES, according to claim 1, wherein the breakdown of the pesticide of the month (6) includes:
the principal brands marketed;
the patent of the pesticide;
the registrations obtained and registrations on the list yet to be released;
the period of application;
the pests that they combat;
the international price history;
the national prices;
the market share in the crops that is marketed;
the exchange ratio;
an analysis of global crop protection.

8) METHOD FOR OFFERING GUIDANCE TO THE AGRIBUSINESS MARKET ON DIFFERENT PARAMETERS CONCERNING AGRICULTURAL PESTICIDES, according to claim 1, wherein the demand (7) presents the demand for pesticides in Brazil and the principal countries that consume pesticides.

9) METHOD FOR OFFERING GUIDANCE TO THE AGRIBUSINESS MARKET ON DIFFERENT PARAMETERS CONCERNING AGRICULTURAL PESTICIDES, according to claim 1, wherein new technologies (8) include a brief commentary on new technologies applied to agricultural pesticides.

10) METHOD FOR OFFERING GUIDANCE TO THE AGRIBUSINESS MARKET ON DIFFERENT PARAMETERS CONCERNING AGRICULTURAL PESTICIDES, according to claim 1, wherein the exchange rate (9) includes the exchange rate history for monitoring by the trader.
